(19) United States
(12) Patent Application Publication
(10) Pub. No.: US 2011/0019103 A1
(43) Pub. Date: Jan. 27, 2011

(54) REMOTE ANTENNA WITH TUNER FOR TV

(75) Inventors: Peter Shintani, San Diego, CA (US); David Mackenzie, Poway, CA (US); Mehrdad Memarnegad, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/506,680

(22) Filed: Jul. 21, 2009

(51) Int. Cl. H04N 5/455

(52) U.S. Cl. 348/726; 348/E05.113

(57) ABSTRACT

An antenna unit for a TV. The antenna unit, which can be roof-mounted, includes a tuner and a demodulator so that it outputs a baseband signal containing IP packets representing a TV signal, requiring only a twisted pair Ethernet-type connection between the antenna unit and TV.

### I. FIELD OF THE INVENTION

The present application relates generally to remote antennas with tuners for a TV.

### II. BACKGROUND OF THE INVENTION

With the transition to digital terrestrial TV, many people will attempt to attach an antenna to their TV set to receive the free over-the-air digital broadcast. As understood herein, many people may become frustrated with the limitations of their indoor antennas although the may not wish to bother with the erection of an outdoor antenna.

With more particularity, indoor antennas suffer the drawbacks of being constrained to relatively small sizes, which can produce poor signal quality. Also, it can be difficult to establish an optimum orientation of an indoor antenna. On the other hand, erecting an outdoor antenna can be complex and can require roof-mounting, which is beyond the skill/physical capability of many people. Moreover, RF signals from outdoor antennas must travel a longer distance to the TV than from indoor antennas and thus can suffer image-degrading line losses of the RF. Accordingly, an inline or remote amplifier may be necessary to compensate for the loss in the feed line, increasing material expense and installation costs.

### SUMMARY OF THE INVENTION

An antenna unit for a TV includes a roof-mountable housing, a TV tuner in the housing, and a demodulator in the housing and communicating with the TV tuner. The housing need not be mounted on the roof, however, but may be mounted at any other convenient location for the user. The demodulator generates a baseband signal for establishing an antenna unit output in a baseband format. Owing to the baseband format of the output signal, a non-coaxial cable can connect the demodulator to a TV in a building defining a roof on which the antenna unit can be mounted such that the TV can display video represented by the baseband signal and carried over the cable.

The output may include IP packets representing a TV signal. The cable may include at least one twisted pair connection and in some embodiments may include four twisted pair connections.

In example implementations the antenna unit receives power from the TV over the cable. If desired, a motor can be coupled to the antenna to move the antenna, with the tuner generating a signal causing the motor to move the antenna. Antenna diversity may also be provided in the unit. For example, the antenna unit can include a second antenna communicating with a second tuner, with the antenna unit selecting the first tuner to establish the output when the first tuner generates an output having a better quality than an output of the second tuner, and otherwise selecting the second tuner to establish the output.

In another aspect, an antenna assembly for a TV includes an antenna remote from the TV and a TV tuner receiving signals from the antenna. The TV tuner is also remote from the TV and may be co-located with the antenna. A demodulator is remote from the TV and receives signals from the TV tuner to generate a baseband signal for transmission thereof to the TV.

In another aspect, an apparatus includes a TV including a TV display but not necessarily including a TV tuner. The apparatus also includes an antenna assembly remote from the TV and including an antenna and a TV tuner receiving signals therefrom. The TV tuner is responsive to control signals from the TV to tune to a TV channel. A communication path is between the TV and antenna assembly. The apparatus outputs a packetized signal using an output of the TV tuner, and the packetized signal represents a video stream and being sent along the communication path to the TV for presenting the video stream on the TV.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic view showing the antenna assembly in TV in a building;

FIG. 2 is a block diagram of a first example embodiment of the antenna assembly;

FIG. 3 is a block diagram of a second example antenna assembly; and

FIG. 4 is a block diagram of a second example embodiment of the antenna assembly.

### DETAILED DESCRIPTION OF THE PREFERRED EMBODIMENT

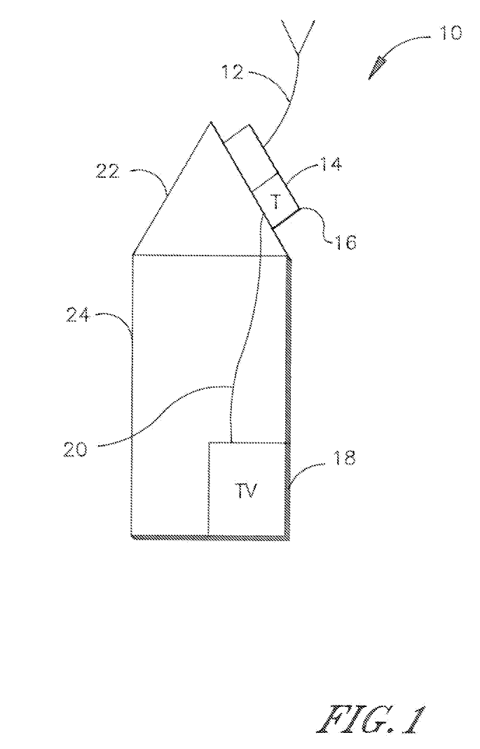

Referring initially to FIG. 1, and antenna assembly 10 includes at least one TV antenna 12, e.g., a dipole antenna, and a TV tuner 14. As shown, in the example antenna assembly 10 the tuner 14 and antenna 12 are supported by a common housing 16, although the assembly 10 may be physically implemented in separate tuner and antenna packages. In any case, the components of the assembly 10 are remote from a TV 18 and connected thereto by a wireless or more preferably wired communication link 20, e.g., the assembly 10 may be mounted on a roof 22 of a building 24 in which the TV 18 is disposed. Other mounting locations for the assembly 10 may be used, e.g., inside the building but distanced from the chassis of the TV, on a pole, window, railing, etc.

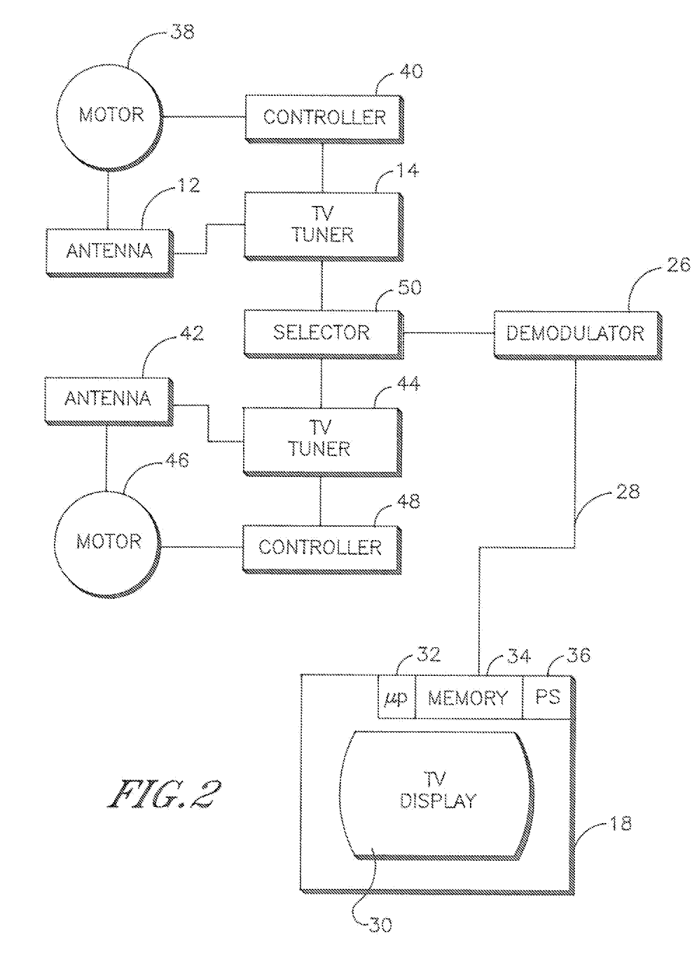

Additional details of an example antenna assembly can be seen in FIG. 2. The antenna 12 receives terrestrial broadcast digital TV signals and sends the signals to the TV tuner 14. In turn, the TV tuner 14, responsive to commands from the TV 18 as set forth further below, tunes to a commanded channel and outputs TV signals received on that channel to a demodulator 26. The demodulator 26 may be integral to the TV tuner 14 or may be physically separate therefrom.

In any case, the demodulator 26 renders the received TV signal into baseband format. As part of this rendering the demodulator 26 (and/or accompanying packetizing circuitry) may produce Internet Protocol (LP) packets representing the received video stream. Or, a proprietary stream or raw transport stream may be sent. In any case, the output is not RF. The baseband signal is sent over a communication path 28 to the TV 18. In one embodiment the communication path 28 is not a coaxial cable since baseband and not RF is being transmitted to the TV for display, but rather may be established by, e.g., a twisted pair cable such as a CAT5 type of Ethernet cable with four twisted pairs.

The TV 18 receives the baseband and presents the video signal on a TV display 30 under control of a TV processor 32 accessing a computer readable memory 34 such as solid state or disk-based storage. The TV 18 may, but need not, contain a TV tuner or terrestrial antenna or even a demodulator since it receives baseband through the tuner 14 in the antenna assembly 10. The TV 18 also typically includes a power source 36 such as an AC power receiver, AC-DC converter, etc. The antenna assembly 10 need not contain any power source of its own but rather can receive “phantom power”, i.e., power from the TV power source 36, through the cable 28. Also, tuner commands from the TV 18 as might be input to the TV by a user remote control are sent to the tuner 14 through the cable 28.

In some embodiments the antenna 12 may be movably mounted on the housing 16. The antenna 12 may be coupled to a motor 38 controlled by an associated motor controller 40. The controller 40 can be responsive to signals from the TV tuner 14 to activate the motor 38 and move, e.g., rotate, the antenna 12 to improve signal reception. As an example, the tuner 14, which may include an internal controller or processor, can determine whether its output signal meets a threshold quality, e.g., a threshold signal-to-noise ratio or bit error rate threshold. If not, the tuner 14 can cause the antenna 12 to be moved into different orientations until the threshold is met.

If desired, some antenna assembly packages may include multiple antenna/tuner pairs and send the best output to the TV. For instance, in addition to the tuner 14 and antenna 12, a second antenna 42 may send terrestrial TV signals to a second tuner 44 of the antenna assembly 10, with the antenna 42 being adjustable by means of a second motor 46 and second motor controller 48, although in some embodiments a single motor may be coupled to both antennas. In any case, the currently “best” tuner output is sent to the TV, with the selected tuner being dynamically established to ensure that the TV receives the best signal.

This may be done by connecting both tuners 14, 44 to a selector switch assembly 50 which is operable to connect the current “best” tuner to the demodulator 26. Or, a separate demodulator may be provided for each antenna/tuner pair in which case the switch assembly 50 can be downstream of the demodulators, i.e. between the demodulators and the TV.

The switch assembly 50 may include an internal controller that receives signals from both tuners and determines (using, e.g., SNR and/or BER) which signal is best. Alternatively, the switch assembly 50 may be a simple hardware and/or software switch that is controlled by the tuners communicating with each other to determine which one is currently outputting the best signal. Indeed, more than two antennas/demodulators may be used, e.g., four may be used for each of the cardinal directions.

As another alternative, the user may be presented with a setup screen on the TV instructing the user to select, by means of a TV remote control, which one of plural antennas/demodulators presented on the TV to use.

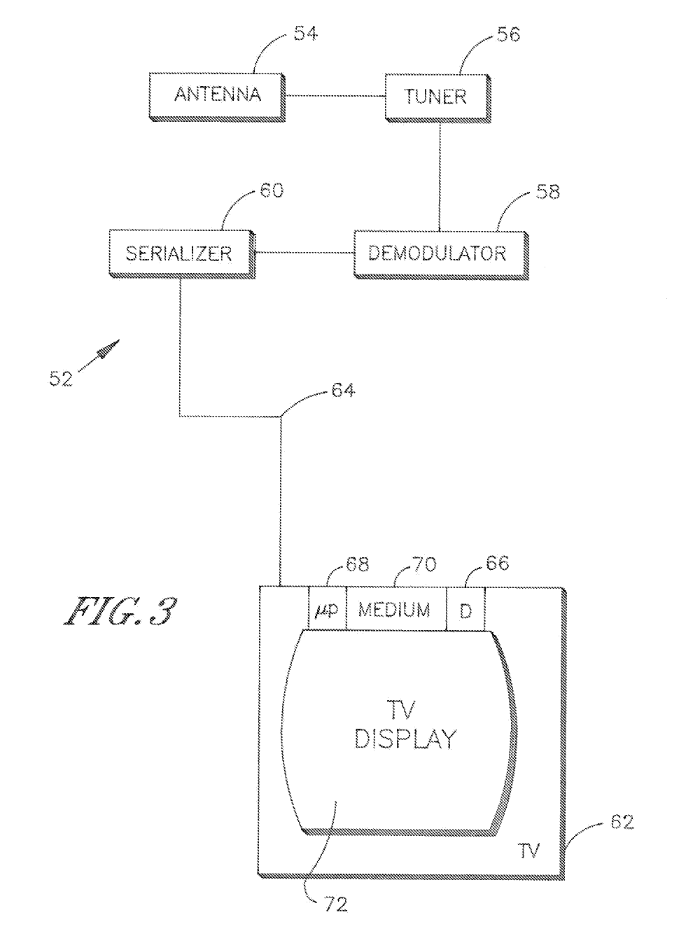

FIG. 3 shows an alternate embodiment in which an antenna assembly, generally designated 52, includes at least one antenna 54 sending terrestrial digital-TV signals to a TV tuner 56. A demodulator 58 receives the output of the tuner and generates a baseband signal in response. The baseband signal is sent to a serializer 60 of the assembly 52, which outputs the serialized baseband signal to a TV 62 over a coaxial cable 64 such as an RG-6 or RG-59 cable. It will thus be appreciated that the embodiment of FIG. 3 may be used if a legacy coaxial cable is already in place in the building 24 between the roof and TV. The components 54, 56, 58, and 60 may be provided as part of a single assembly and may be housed together.

When the embodiment of FIG. 3 is used, the serialized baseband signal is received by a demodulator 66 in the TV 62. The demodulator 66 may be controlled by a TV processor 68 accessing a computer readable medium 70 to output video stream signals suitable for presentation on a TV display 72.

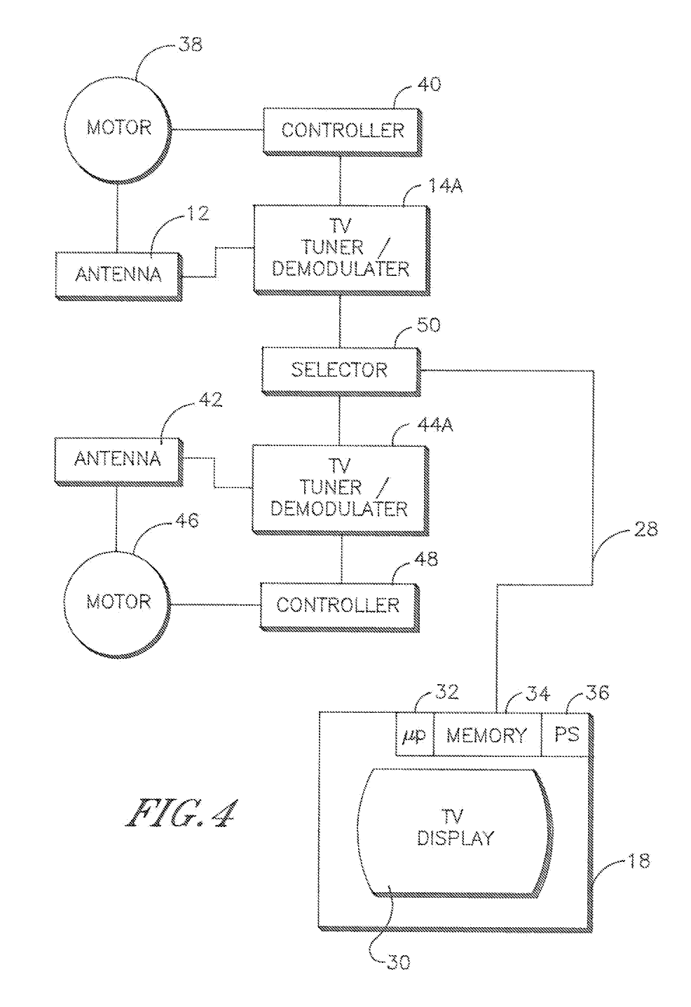

FIG. 4 shows an alternate assembly that is an all essential respects identical to that in FIG. 2, except that the tuners 14, 44 have been replaced with respective integrated tuner/demodulators 14A, 44A, each containing a tuner and an associated demodulator. Accordingly the single demodulator 26 shown in FIG. 2 downstream of the selector 50 is eliminated in FIG. 4. The selector 50 functions as described above to select the “best” tuner/demodulator 14A, 44A.

While the particular REMOTE ANTENNA WITH TUNER FOR TV is herein shown and described in detail, it is to be understood that the subject matter which is encompassed by the present invention is limited only by the claims.

What is claimed is:

1. An antenna unit for a TV comprising:
a housing;
a TV tuner in the housing; and
a demodulator in the housing and communicating with the TV tuner, the demodulator generating a baseband signal for establishing an antenna unit output in a baseband format; wherein
owing to the baseband format of the output signal a non-coaxial cable can connect the demodulator to a TV in a building on which the antenna unit can be mounted such that the TV can display video represented by the baseband signal and carried over the cable.

2. The antenna unit of claim 1, wherein the output includes IP packets representing a TV signal.

3. The antenna unit of claim 1, wherein the cable includes at least one twisted pair connection.

4. The antenna unit of claim 3, wherein the cable includes four twisted pair connections.

5. The antenna unit of claim 1, wherein the antenna unit receives power from the TV over the cable.

6. The antenna unit of claim 1, comprising a motor coupled to the antenna to move the antenna, the tuner generating a signal causing the motor to move the antenna.

7. The antenna unit of claim 1, wherein the antenna is a first antenna and the tuner is a first tuner and the antenna unit includes a second antenna communicating with a second tuner, the antenna unit selecting the first tuner to establish the output when the first tuner generates an output having a better quality than an output of the second tuner, and otherwise selecting the second tuner to establish the output.

8. An antenna assembly for a TV, comprising:
an antenna remote from the TV;
a TV tuner receiving signals from the antenna, the TV tuner being remote from the TV;
a demodulator remote from the TV and receiving signals from the TV tuner and generating a baseband signal for transmission thereof to the TV.

9. The antenna assembly of claim 8, comprising a serializer remote from the TV and receiving signals from the demodulator, a coaxial cable connecting the serializer to the TV.

10. The antenna assembly of claim 8, wherein the baseband signal establishes an output in a baseband format; wherein owing to the baseband format of the output a non-coaxial cable can connect the demodulator to the TV.

11. The antenna assembly of claim 10, wherein the output includes IP packets representing a TV signal.

12. The antenna assembly of claim 10, wherein the cable includes at least one twisted pair connection.

13. The antenna assembly of claim 8, wherein the antenna assembly receives power from the TV over a cable.

14. The antenna assembly of claim 8, comprising a motor coupled to the antenna to move the antenna, the tuner generating a signal causing the motor to move the antenna.

15. The antenna assembly of claim 8, wherein the antenna is a first antenna and the tuner is a first tuner and the antenna assembly includes a second antenna communicating with a second tuner, the antenna assembly selecting the first tuner to establish the output when the first tuner generates an output having a better quality than an output of the second tuner, and otherwise selecting the second tuner to establish the output.

16. Apparatus comprising:
TV including a TV display and not necessarily including a TV tuner;
antenna assembly remote from the TV and including an antenna and a TV tuner receiving signals therefrom, the TV tuner being responsive to control signals from the TV to tune to a TV channel;
communication path between the TV and antenna assembly;
the apparatus outputting a packetized signal using an output of the TV tuner, the packetized signal representing a video stream and being sent along the communication path to the TV for presenting the video stream on the TV.

17. Apparatus of claim 16, wherein the antenna assembly includes a demodulator receiving an output of the TV tuner and generating a baseband signal representative of the output of the TV tuner.

18. Apparatus of claim 17, comprising a serializer remote from the TV and receiving signals from the demodulator, a coaxial cable connecting the serializer to the TV.

19. Apparatus of claim 16, wherein the communication path is established by a non-coaxial cable.

20. Apparatus of claim 16, comprising a motor coupled to the antenna to move the antenna, the tuner generating a signal causing the motor to move the antenna.
